(19) United States
(12) Patent Application Publication
(10) Pub. No.: US 2017/0168679 A1
(43) Pub. Date: Jun. 15, 2017

(54) METHOD AND ELECTRONIC DEVICE FOR ARRANGING DESKTOP ICONS

(71) Applicants: Le Holdings (Beijing) Co., Ltd., Beijing (CN); Lemobile Information Technology (Beijing) Co., Ltd, Beijing (CN)

(72) Inventor: Shufeng Ren, Beijing (CN)

(73) Assignees: Le Holdings (Beijing) Co., Ltd., Beijing (CN); Lemobile Information Technology (Beijing) Co., Ltd ., Beijing (CN)

(21) Appl. No.: 15/242,664

(22) Filed: Aug. 22, 2016

Related U.S. Application Data
(63) Continuation of application No. PCT/CN2016/088527, filed on Jul. 5, 2016.

(30) Foreign Application Priority Data
Dec. 9, 2015 (CN) 201510904245.1

(51) Int. Cl. G06F 3/0481; G06F 3/0346

(52) U.S. Cl. CPC G06F 3/04817; G06F 3/0346

(57) ABSTRACT

This disclosure provides a method and electronic device for arranging desktop icons. When a desktop icon rearrangement function is opened, judge whether a vacancy exists among the desktop icons or not; if the vacancy exists, then acquire a kinematic acceleration of a mobile phone, and judge whether the kinematic acceleration is greater than a preset threshold or not. If the kinematic acceleration is greater than the preset threshold value, then continuously arrange the desktop icons. Thus, the user can achieve automatic and continuous arrangement of desktop disclosure icons by a shaking action, and fill up the vacancy existing among the desktop disclosure icons, thereby facilitating use of the mobile phone by the user; and the shaking action is convenient to operate and is clear and reliable.

### CROSS REFERENCE TO RELATED APPLICATIONS

This disclosure is a continuation of International Application No. PCT/CN2016/088527 filed on Jul. 5, 2016, which is based upon and claims priority to Chinese Patent Application No. 201510904245.1, filed on Dec. 9, 2015, titled “METHOD AND SYSTEM FOR ARRANGING DESKTOP ICONS”, and the entire contents of which are incorporated herein by reference.

### TECHNICAL FIELD

This disclosure relates to the field of mobile communications, and specifically to a method and electronic device for arranging desktop icons.

### BACKGROUND

With the development of mobile communication technologies and the continuous improvement of people's living standard, all kinds of mobile communication devices have become indispensable communication tools in people's life. As an important mobile communication device in people's daily life, a smart phone has large user groups. A lot of desktop applications may be installed in the smart phone, in particular, a general smart phone with an android system, thereby greatly enriching the user experience.

When a user uses a smart phone, some desktop applications may be added or deleted as required, and the deletion operation will leave vacancies among the desktop disclosure icons of the mobile phone, resulting in relatively scattered arrangement of the desktop disclosure icons; and when the user needs to look for a certain desktop disclosure, the user needs to turn over more desktop disclosure icons, which is less efficient. In the prior art, if the vacancies caused by the deletion operation needs to be filled up, the user needs to manually move the desktop disclosure icons one by one to realize continuous arrangement of the icons, and the user experience of this kind of operation is poor.

### SUMMARY

This disclosure provides a method and an electronic device for arranging desktop icons, by which energy consumption can be reduced, a user can realize automatic and continuous arrangement of desktop disclosure icons by a shaking action, and the vacancy among the desktop disclosure icons is filled up to facilitate use of the mobile phone by the user.

One objective of the embodiments of this disclosure is to provide a method for arranging desktop icons, including the following steps: judging whether a desktop icon rearrangement function is opened or not; if the desktop icon rearrangement function is opened, then judging whether a vacancy exists among the desktop icons or not; if the vacancy exists among the desktop icons, then acquiring a kinematic acceleration of a mobile phone, and judging whether the kinematic acceleration is greater than a preset threshold or not; and if the kinematic acceleration is greater than the preset threshold, then continuously arranging the desktop icons.

Preferably, the step of continuously arranging the desktop icons includes moving an icon after a vacancy forward to the vacancy successively and cyclically until no vacancy exists.

Preferably, the step of continuously arranging the desktop icons includes continuously arranging the desktop icons by the frequency of operations; or continuously arranging the desktop icons by installation time; or continuously arranging the desktop icons by name.

Preferably, the step of acquiring the kinematic acceleration of the mobile phone includes: acquiring a first acceleration of an X axis of the mobile phone in a horizontal moving direction; acquiring a second acceleration of a Y axis of the mobile phone in a vertical moving direction; acquiring a third acceleration of a Z axis in a direction of the earth gravity field; and acquiring the kinematic acceleration according to the first acceleration, the second acceleration and the third acceleration.

Preferably, the step of acquiring the kinematic acceleration according to the first acceleration, the second acceleration and the third acceleration is:

N=\sqrt{X²+Y²+Z²}, where
N is the kinematic acceleration;
X is the first acceleration;
Y is the second acceleration; and
Z is the third acceleration.

Another objective of the embodiments of this disclosure is to provide an electronic device comprising at least one processor and a memory in communication connection with the at least one processor; where, the memory stores instructions that can be executed by the at least one processor, and the instructions are executed by the at least one processor to enable the at least one processor to: judge whether a desktop icon rearrangement function is opened or not; judge whether a vacancy exists among the desktop icons or not if the rearrangement function is opened; acquire a kinematic acceleration of a mobile phone if a vacancy exists among the desktop icons, and judge whether the kinematic acceleration is greater than a preset threshold or not; and continuously arrange the desktop icons if the kinematic acceleration is greater than the preset threshold.

According to the electronic device, the step of continuously arranging the desktop icons includes: moving an icon after a vacancy forward to the vacancy successively and cyclically until no vacancy exists.

According to the electronic device, the step of continuously arranging the desktop icons includes: continuously arranging the desktop icons by the frequency of operations; or continuously arranging the desktop icons by installation time; or continuously arranging the desktop icons by name.

According to the electronic device, the step of acquiring the kinematic acceleration of the mobile phone includes: acquiring a first acceleration of an X axis of the mobile phone in a horizontal moving direction, acquiring a second acceleration of a Y axis of the mobile phone in a vertical moving direction, acquiring a third acceleration of a Z axis in a direction of the earth gravity field, and acquiring the kinematic acceleration according to the first acceleration, the second acceleration and the third acceleration.

According to the electronic device, the mode of obtaining the kinematic acceleration according to the first acceleration, the second acceleration and the third acceleration is as follows:

N=\sqrt{X²+Y²+Z²}, where
N is the kinematic acceleration;
X is the first acceleration;
Y is the second acceleration; and
Z is the third acceleration.

Another objective of the embodiments of this disclosure is to provide a non-volatile computer storage medium storing computer executable instructions that, when executed by the electronic device, enable the electronic device to: judge whether a desktop icon rearrangement function is opened or not; if the desktop icon rearrangement function is opened, then judge whether a vacancy exists among the desktop icons or not; if the vacancy exists among the desktop icons, then acquire a kinematic acceleration of a mobile phone, and judge whether the kinematic acceleration is greater than a preset threshold or not; and if the kinematic acceleration is greater than the preset threshold, then continuously arrange the desktop icons.

According to the non-volatile computer storage medium, the step of continuously arranging the desktop icons includes: moving an icon after a vacancy forward to the vacancy successively and cyclically until no vacancy exists.

According to the non-volatile computer storage medium, the step of continuously arranging the desktop icons includes: continuously arranging the desktop icons by the frequency of operations; or continuously arranging the desktop icons by installation time; or continuously arranging the desktop icons by name.

According to the non-volatile computer storage medium, the step of acquiring the kinematic acceleration of the mobile phone includes: acquiring a first acceleration of an X axis of the mobile phone in a horizontal moving direction, acquiring a second acceleration of a Y axis of the mobile phone in a vertical moving direction, acquiring a third acceleration of a Z axis in a direction of the earth gravity field; and acquiring the kinematic acceleration according to the first acceleration, the second acceleration and the third acceleration.

According to the non-volatile computer storage medium, the mode of obtaining the kinematic acceleration according to the first acceleration, the second acceleration and the third acceleration is as follows:

N=\sqrt{X²+Y²+Z²}, where
N is the kinematic acceleration;
X is the first acceleration;
Y is the second acceleration; and
Z is the third acceleration.

The method and the electronic device for arranging the desktop icons provided by the embodiments of this disclosure judge whether a vacancy exists among the desktop icons or not when a desktop icon rearrangement function is opened; if there is a vacancy, acquire a kinematic acceleration of a mobile phone and judge whether the kinematic acceleration is greater than a preset threshold or not; and continuously arrange the desktop icons if the kinematic acceleration is greater than the preset threshold. Because whether a vacancy exists among the desktop icons or not is judged only when the desktop icon rearrangement function is opened, and the kinematic acceleration of the mobile phone is acquired only when a vacancy exists among the desktop icons, the energy consumption is saved; meanwhile, because the kinematic acceleration will be greater than the preset threshold when a user does an action of shaking or the like, the user can achieve automatic and continuous arrangement of desktop disclosure icons through a shaking action, and fill up the vacancy existing among the desktop disclosure icons, so as to facilitate using the mobile phone by the user; and the shaking action is convenient to operate and is clear and reliable.

According to the method and the electronic device for arranging desktop icons provided by the embodiments of this disclosure, the method for continuously arranging the desktop icons includes the following steps: moving an icon after a vacancy forward to the vacancy successively and cyclically until no vacancy exists; or continuously arranging the desktop icons by the frequency of operations; or continuously arranging the desktop icons by installation time; or continuously arranging the desktop icons by name. The method and the electronic device provide a variety of ways of continuous arrangement, which are convenient for selection and use by users.

The method and the electronic device for arranging the desktop icons provided by the embodiments of this disclosure acquire a first acceleration of an X axis of the mobile phone in a horizontal moving direction; acquire a second acceleration of a Y axis of the mobile phone in a vertical moving direction; acquire a third acceleration of a Z axis in a direction of the earth gravity field; and acquire a kinematic acceleration according to the first acceleration, the second acceleration and the third acceleration. Such technical method is simple and reliable, and can be implemented by an acceleration transducer at relatively low cost.

### BRIEF DESCRIPTION OF THE DRAWINGS

One or more embodiments are illustrated by way of example, and not by limitation, in the figures of the accompanying drawings, where elements having the same reference numeral designations represent like elements throughout. The drawings are not to scale, unless otherwise disclosed.

FIG. 1 is a flow chart of a specific example of a method for arranging desktop icons in accordance with Embodiment 1 of this disclosure;

FIG. 2 is a functional block diagram of a specific example of a system for arranging desktop icons in accordance with Embodiment 2 of this disclosure; and

FIG. 3 is a schematic diagram of a hardware structure of an electronic device for executing the method for arranging desktop icons in accordance with Embodiment 4 of this disclosure.

The reference numerals in the drawings are as follows: 1—Arrangement function judging module, 2—Vacancy judging module, 3—Kinematic acceleration judging module, 4—Arrangement module, 5—Memory, and 6—Processor.

### DETAILED DESCRIPTION

To make the objectives, the technical scheme and the advantages of the embodiments of this disclosure clearer, the technical scheme of this disclosure will be clearly and completely described hereinafter through implementation with reference to the accompanying drawings in the embodiments of this disclosure. Apparently, the embodiments described below are a part, but not all, of the embodiments of this disclosure.

### Embodiment 1

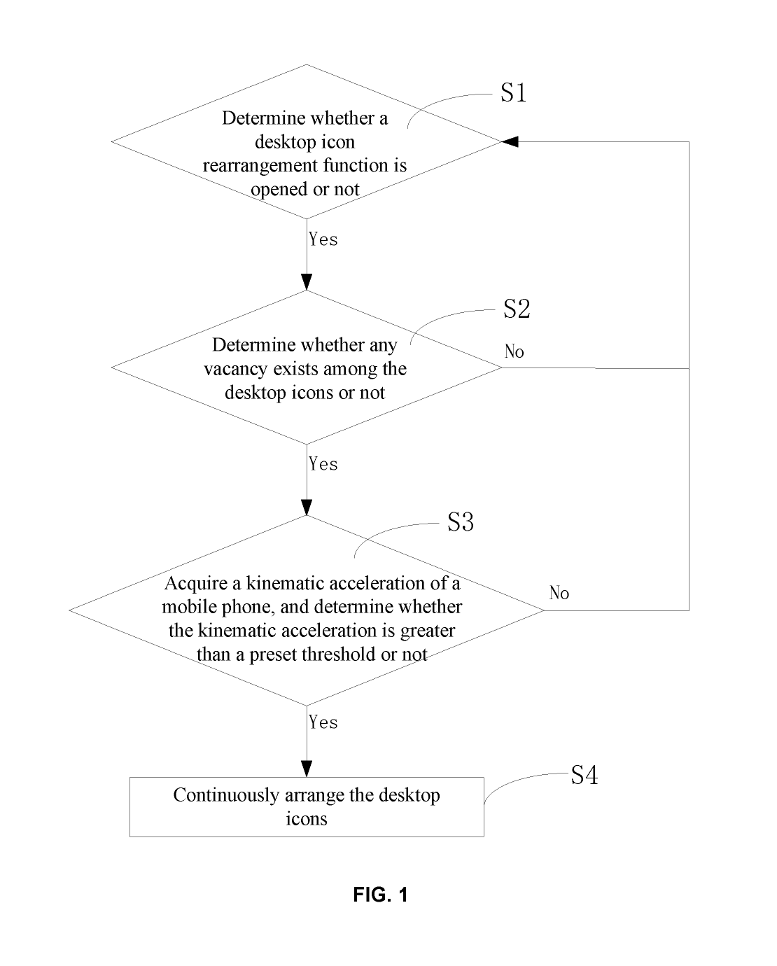

As shown in FIG. 1, this embodiment provides a method for arranging desktop icons, including the following steps:

S1: judging whether a desktop icon rearrangement function is opened or not, and proceeding to step S2 if the desktop icon rearrangement function is opened; or continuing to perform step S1 if the desktop icon rearrangement function is not opened;

S2: judging whether a vacancy exists among the desktop icons or not; proceeding to step S3 if the vacancy exists among the desktop icons; or performing step S1 if no vacancy exists among the desktop icons;

S3: acquiring a kinematic acceleration of a mobile phone, judging whether the kinematic acceleration is greater than a preset threshold or not; and proceeding to step S4 if the kinematic acceleration is greater than the preset threshold, or performing step S1 if the kinematic acceleration is not greater than the preset threshold. The preset threshold in this step may be set as appropriate; and

S4: continuously arranging the desktop icons. In a specific disclosure, this step may be implemented specifically by: moving an icon after a vacancy forward to the vacancy successively and cyclically until no vacancy exists, for example, moving in sequence along the direction of the X axis at first and then the Y axis; or moving in sequence along the direction of the Y axis at first and then the X axis; or continuously arranging the desktop icons by the frequency of operations; or continuously arranging the desktop icons by installation time; or continuously arranging the desktop icons by name. It should be appreciated by those skilled in the art that the desktop icons may also be continuously arranged in other ways, which may be set specifically as appropriate.

In steps S1-S4, whether a vacancy exists among the desktop icons or not is judged only when the desktop icon rearrangement function is opened, and the kinematic acceleration of the mobile phone is acquired only when the vacancy exists among the desktop icons, so that the energy consumption is saved; meanwhile, because the kinematic acceleration will be greater than the preset threshold when a user does an action of shaking or the like, the user can achieve automatic and continuous arrangement of desktop disclosure icons by a shaking action, and fill up a vacancy existing among the desktop disclosure icons, thereby facilitating use of the mobile phone by the user; and the shaking action is convenient to operate and is clear and reliable.

Based on the above-mentioned solution, the step of acquiring the kinematic acceleration of the mobile phone in step S3 includes:

firstly, acquiring a first acceleration of an X axis of the mobile phone in a horizontal moving direction, acquiring a second acceleration of a Y axis of the mobile phone in a vertical moving direction, and acquiring a third acceleration of a Z axis in a direction of the earth gravity field; and

secondly, obtaining the kinematic acceleration according to the first acceleration, the second acceleration and the third acceleration. As a specific implementation, N=\sqrt{X²+Y²+Z²}, where, N is the first kinematic acceleration, X is the first acceleration, Y is the second acceleration, and Z is the third acceleration.

The method for acquiring the kinematic acceleration in this way is simple and reliable, can be implemented by an acceleration transducer at relatively low cost.

### Embodiment 2

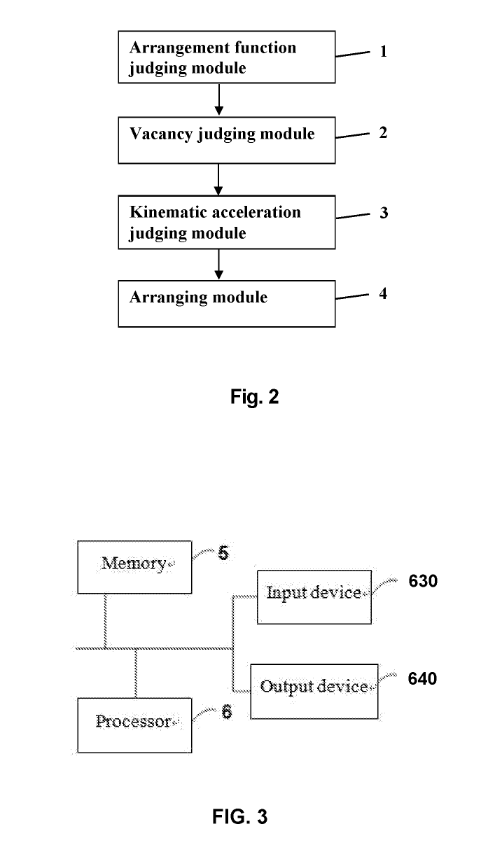

As shown in FIG. 2, the present embodiment provides a system for arranging desktop icons, which may include the following modules: an arrangement function judging module 1, for judging whether a desktop icon rearrangement function is opened or not; a vacancy judging module 2, for, when the rearrangement function is opened, judging whether a vacancy exists among the desktop icons or not; a kinematic acceleration judging module 3, for, when the vacancy exists among the desktop icons, acquiring a kinematic acceleration of a mobile phone, and judging whether the kinematic acceleration is greater than a preset threshold or not; and an arrangement module 4, for, when the kinematic acceleration is greater than the preset threshold, continuously arranging the desktop icons.

According to the system for arranging the desktop icons provided by the present embodiment, whether a vacancy exists among the desktop icons or not is judged only when a desktop icon rearrangement function is opened; a kinematic acceleration of a mobile phone is acquired only when there is the vacancy among the desktop icons, and the energy consumption is saved; meanwhile, because the kinematic acceleration will be greater than the preset threshold when a user does an action of shaking or the like, the user can achieve automatic and continuous arrangement of desktop disclosure icons by a shaking action, and fill up the vacancy existing among the desktop disclosure icons, thereby facilitating use of the mobile phone by the user; and the shaking action is convenient to operate and is clear and reliable.

Based on the above-mentioned solution, the arrangement module 4 may include the following sub-modules: a cyclic sub-module, for moving an icon after the vacancy forward to the vacancy successively and cyclically until no vacancy exists; a operation frequency-based arrangement sub-module, for continuously arranging the desktop icons by the operation frequency; or an installation time-based arrangement sub-module, for continuously arranging the desktop icons by installation time; or a name-based arrangement sub-module, for continuously arranging the desktop icons by name. It should be appreciated by those skilled in the art that the desktop icons may also be continuously arranged in other ways, and only need to be set specifically as required.

Based on the above-mentioned solution, the kinematic acceleration judging module 3 may include the following sub-modules: a triaxial acceleration acquisition sub-module, for acquiring a first acceleration of an X axis of the mobile phone in a horizontal moving direction, acquiring a second acceleration of a Y axis of the mobile phone in a vertical moving direction, and acquiring a third acceleration of a Z axis in a direction of the earth gravity field; and a resulting sub-module, for acquiring the kinematic acceleration according to the first acceleration, the second acceleration and the third acceleration. The resulting sub-module can acquire the kinematic acceleration in the following way: N=\sqrt{X²+Y²+Z²}, where, N is the kinematic acceleration, X is the first acceleration, Y is the second acceleration, and Z is the third acceleration.

The method for acquiring the kinematic acceleration in this way is simple and reliable, can be implemented by an acceleration transducer at relatively low cost.

### Embodiment 3

The embodiment of this disclosure provides a non-volatile computer storage medium storing computer executable instructions that can be used for executing the method for arranging desktop icons in any one of the above-mentioned embodiments of the method.

The non-volatile computer storage medium stores computer executable instructions that, when executed by the electronic device, enable the electronic device to: judge whether a desktop icon rearrangement function is opened or not; if the desktop icon rearrangement function is opened, judge whether a vacancy exists among the desktop icons or not; if the vacancy exists among the desktop icons, acquire a kinematic acceleration of a mobile phone, and judge whether the kinematic acceleration is greater than a preset threshold or not; and if the kinematic acceleration is greater than the preset threshold, continuously arrange the desktop icons.

According to the non-volatile computer storage medium, the step of continuously arrange the desktop icons includes moving an icon after a vacancy forward to the vacancy successively and cyclically until no vacancy exists.

According to the non-volatile computer storage medium, the step of continuously arranging the desktop icons includes: continuously arranging the desktop icons by the frequency of operations; or continuously arranging the desktop icons by installation time; or continuously arranging the desktop icons by name.

According to the non-volatile computer storage medium, the step of acquiring the kinematic acceleration of the mobile phone includes: acquiring a first acceleration of an X axis of the mobile phone in a horizontal moving direction, acquiring a second acceleration of a Y axis of the mobile phone in a vertical moving direction, acquiring a third acceleration of a Z axis in a direction of the earth gravity field, and acquiring the kinematic acceleration according to the first acceleration, the second acceleration and the third acceleration.

According to the non-volatile computer storage medium, the mode of acquiring the kinematic acceleration according to the first acceleration, the second acceleration and the third acceleration is as follows:

N=\sqrt{X²+Y²+Z²}, where
N is the kinematic acceleration;
X is the first acceleration;
Y is the second acceleration; and
Z is the third acceleration.

### Embodiment 4

FIG. 3 is a schematic diagram of a hardware structure of the electronic device for executing the method for arranging desktop icons in the embodiment of this disclosure, and as shown in FIG. 3, the device includes one or more processors 6 and a memory 5, and one processor 6 is taken as an example in FIG. 3; and the electronic device for executing the method for arranging desktop icons may also include an input device 630 and an output device 640.

The processor 6, the memory 5, the input device 630 and the output device 640 may be connected with a bus or in other ways, and bus connection is taken as an example in FIG. 3.

The memory 5, as a non-volatile computer readable storage medium, may be used for storing non-volatile software programs, non-volatile computer executable programs and modules, for example, program instructions/modules (e.g., an arrangement function judging module 1, a vacancy judging module 2, a kinematic acceleration judging module 3 and an arranging module 4 shown in FIG. 2) corresponding to the method for arranging desktop icons in the embodiments of this disclosure. The processor 6 runs the non-volatile software programs, instructions and modules stored in the memory 5 so as to execute various functional applications and data processing of a server, thereby implementing the method for arranging desktop icons in the abovementioned embodiments of the method.

The memory 5 may include a program storage area and a data storage area, where the program storage area may store an operating system and applications for at least one functions; and the data storage area may store data and the like created according to the use of a device for arranging desktop icons. Moreover, the memory 5 may include a high-speed random access memory, and may also include a non-volatile memory, for example, at least one disk memory device, a flash memory, or other non-volatile solid memory devices. In some embodiments, the memory 5 optionally includes memories that are set remotely relative to the processor 6, and these remote memories may be connected to the device for arranging desktop icons through a network. An example of the network includes, but is not limited to, internet, intranet, LAN, mobile communication network, and the combinations thereof.

The input device 630 may receive input digit or character information, and generate a key signal input related to the user configuration and function control of the device for arranging desktop icons. The output device 640 may include display devices such as a display screen.

The one or more modules are stored in the memory 5, and when executed by the one or more processors 6, perform the method for arranging desktop icons in any one of the abovementioned embodiments of the method.

The abovementioned product can execute the method provided by the embodiments of this disclosure and has corresponding functional modules for executing the method and beneficial effects. For more technical details of this embodiment, please refer to the method provided by the embodiments of this disclosure.

The electronic device of the embodiments of this disclosure exists in many forms, including but not limited to the following devices:

(1) Mobile communication devices: the characteristic of such devices is that they have a mobile communication function with a main goal of enabling voice and data communication. Such terminals include: smart phones (such as iPhone), multimedia phones, feature phones, low-end phones, etc.

(2) Ultra-mobile personal computer devices: such devices belong to the category of personal computers, have computing and processing functions, and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, smart toys, and portable vehicle navigation devices.

(4) Servers: devices providing computing services. The structure of a server includes a processor, a hard disk, an internal memory, a system bus, etc. A server has architecture similar to that of a general purpose computer, but in order to provide highly reliable services, the server has higher requirements in aspects of processing capability, stability, reliability, security, expandability, manageability, etc.

(5) Other electronic devices having data interaction function.

The abovementioned device embodiments are only illustrative, where the units described as separate parts may be or may not be physically separated, the components shown as units may be or may not be physical units, i.e. may be located in one place, or may be distributed at multiple network units. According to actual needs, part of or all of the modules therein may be selected to realize the objectives of the technical scheme of the embodiment.

By abovementioned descriptions of the implementations, those skilled in the art can clearly understand that the various implementations may be implemented by software and a general hardware platform, and of course, may also be implemented just by hardware. Based on such understanding, the abovementioned technical scheme in essence, or the part thereof making contribution to a related technology, may be embodied in the form of a software product, and such computer software products may be stored in a computer readable storage medium such as an ROM/RAM, a magnetic disk or an optical disk, etc., and may include a number of instructions to enable a computer device (which may be a personal computer, a server, or a network device, etc.) to execute the methods described in the various embodiments or in some parts thereof.

Finally, it should be noted that: the abovementioned embodiments are merely illustrated for describing rather than limiting the technical scheme of this disclosure; although detailed description of this disclosure is given with reference to the abovementioned embodiments, those skilled in the art should understand that they still can modify the technical scheme recorded in the abovementioned various embodiments or replace part of the technical features therein with equivalents; and these modifications or replacements would not cause the essence of the corresponding technical scheme to depart from the spirit and scope of the technical scheme of the various embodiments of this disclosure.

What is claimed is:

1. A method for arranging desktop icons, comprising the following steps:
judging whether a desktop icon rearrangement function is opened or not;
if the desktop icon rearrangement function is opened, then judging whether a vacancy exists among the desktop icons or not;
if the vacancy exists among the desktop icons, then acquiring a kinematic acceleration of a mobile phone, and judging whether the kinematic acceleration is greater than a preset threshold or not; and
if the kinematic acceleration is greater than the preset threshold, continuously arranging the desktop icons.

2. The method according to claim 1, wherein the step of continuously arranging the desktop icons comprises: moving an icon after a vacancy forward to the vacancy successively and cyclically until no vacancy exists.

3. The method according to claim 1, wherein the step of continuously arranging the desktop icons comprises:
continuously arranging the desktop icons by the frequency of operations; or
continuously arranging the desktop icons by installation time; or
continuously arranging the desktop icons by name.

4. The method according to claim 1, wherein the step of acquiring the kinematic acceleration of the mobile phone comprises:
acquiring a first acceleration of an X axis of the mobile phone in a horizontal moving direction, acquiring a second acceleration of a Y axis of the mobile phone in a vertical moving direction, acquiring a third acceleration of a Z axis in a direction of the earth gravity field; and
acquiring the kinematic acceleration according to the first acceleration, the second acceleration and the third acceleration.

5. The method according to claim 4, wherein the step of acquiring the kinematic acceleration according to the first acceleration, the second acceleration and the third acceleration is:
N=\sqrt{X²+Y²+Z²}, where
N is the kinematic acceleration;
X is the first acceleration;
Y is the second acceleration; and
Z is the third acceleration.

6. An electronic device, comprising:
at least one processor; and
a memory in communication connection with the at least one processor;
wherein the memory stores instructions that can be executed by the at least one processor, and the instructions are executed by the at least one processor to enable the at least one processor to:
judge whether a desktop icon rearrangement function is opened or not;
judge whether a vacancy exists among the desktop icons or not if the rearrangement function is opened;
if the vacancy exists among the desktop icons, acquire a kinematic acceleration of a mobile phone, and judge whether the kinematic acceleration is greater than a preset threshold or not; and
continuously arrange the desktop icons if the kinematic acceleration is greater than the preset threshold.

7. The electronic device according to claim 6, wherein the step of continuously arranging the desktop icons comprises: moving an icon after a vacancy forward to the vacancy successively and cyclically until no vacancy exists.

8. The electronic device according to claim 6, wherein the step of continuously arranging the desktop icons comprises: continuously arranging the desktop icons by the frequency of operations; or continuously arranging the desktop icons by installation time; or continuously arranging the desktop icons by name.

9. The electronic device according to claim 6, wherein the step of acquiring the kinematic acceleration of the mobile phone comprises: acquiring a first acceleration of an X axis of the mobile phone in a horizontal moving direction, acquiring a second acceleration of a Y axis of the mobile phone in a vertical moving direction, acquiring a third acceleration of a Z axis in a direction of the earth gravity field, and acquiring the kinematic acceleration according to the first acceleration, the second acceleration and the third acceleration.

10. The electronic device according to claim 9, wherein the mode of obtaining the kinematic acceleration according to the first acceleration, the second acceleration and the third acceleration is as follows:
N=\sqrt{X²+Y²+Z²}, where
N is the kinematic acceleration;
X is the first acceleration;
Y is the second acceleration; and
Z is the third acceleration.

11. A non-volatile computer storage medium, storing computer executable instructions that, when executed by the electronic device, enable the electronic device to: judge whether a desktop icon rearrangement function is opened or not; if the desktop icon rearrangement function is opened, then judge whether a vacancy exists among the desktop icons or not; if the vacancy exists among the desktop icons, then acquire a kinematic acceleration of a mobile phone, and judge whether the kinematic acceleration is greater than a preset threshold or not; and if the kinematic acceleration is greater than the preset threshold, continuously arrange the desktop icons.

12. The non-volatile computer storage medium according to claim 11, wherein the step of continuously arranging the desktop icons comprises: moving an icon after a vacancy forward to the vacancy successively and cyclically until no vacancy exists.

13. The non-volatile computer storage medium according to claim 11, wherein the step of continuously arranging the desktop icons comprises: continuously arranging the desktop icons by the frequency of operations; or continuously arranging the desktop icons by installation time; or continuously arranging the desktop icons by name.

14. The non-volatile computer storage medium according to claim 11, wherein the step of acquiring the kinematic acceleration of the mobile phone comprises: acquiring a first acceleration of an X axis of the mobile phone in a horizontal moving direction, acquiring a second acceleration of a Y axis of the mobile phone in a vertical moving direction, acquiring a third acceleration of a Z axis in a direction of the earth gravity field; and acquiring the kinematic acceleration according to the first acceleration, the second acceleration and the third acceleration.

15. The non-volatile computer storage medium according to claim 14, wherein the mode of acquiring the kinematic acceleration according to the first acceleration, the second acceleration and the third acceleration is as follows:
N=\sqrt{X²+Y²+Z²}, where
N is the kinematic acceleration;
X is the first acceleration;
Y is the second acceleration; and
Z is the third acceleration.
